(19) United States
(12) Patent Application Publication
(10) Pub. No.: US 2010/0178101 A1
(43) Pub. Date: Jul. 15, 2010

(54) JOINT MECHANISM FOR ROBOT

(75) Inventors: CHIA-PENG DAY, Santa Clara, CA (US); CHOU-CHEN SHIH, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/471,544

(22) Filed: May 26, 2009

(30) Foreign Application Priority Data
Jan. 10, 2009 (CN) 200910300132.5

(51) Int. Cl. F16B 7/00

(52) U.S. Cl. 403/112; 403/165

(57) ABSTRACT

A joint mechanism includes a first rotary unit and a second rotary unit. The first rotary unit includes a base and a first joining end. The first joining end defines a first chamfered rim. The second rotary unit includes a second joining end to join to the first joining end. The second joining end defines a second chamfered rim. The first chamfered rim and the second chamfered rim cooperatively form a slanted groove. The groove communicates with an outside of the first and second rotary units and has an opening facing the base.

### BACKGROUND

1. Technical Field

The present disclosure generally relates to joint mechanism and, particularly, to a joint mechanism for robots.

2. Description of Related Art

Industrial robotic machines are used to carry out repetitious, precise, burdensome, and even dangerous tasks, such as welding and painting of components. Therefore, industrial robotic machines are popular in the many fields such as mechanical manufacturing, metallurgy, and atomic domain. The robotic machine usually has a plurality of rotary joints to perform complex movements. Two rotary units having rotary joints are usually connected together and rotate relative to each other. A gap exists between the rotary units because there needs to be a space that allows the rotary units to rotate relative to each other.

However, when the robotic machine runs under poor conditions, for example in an environment contaminated with grease and dirt, the adjoining surfaces of the rotary units easily collect contaminants such as oil, dirt, and liquid substances. Thus, contaminants can easily enter the rotary units when the rotary joints rotate, and impair internal components of the robotic machine, as a result, affecting the performance of the robotic machine.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an assembled, perspective view of one embodiment of a joint mechanism having a first rotary unit and a second rotary unit.

FIG. 2 is a perspective view of the first rotary unit of the joint mechanism of FIG. 1.

FIG. 3 is a perspective view of the second rotary unit of the joint mechanism of FIG. 1.

FIG. 4 is an assembled, perspective view of the joint mechanism, showing a first state of the joint mechanism of FIG. 1.

### DETAILED DESCRIPTION

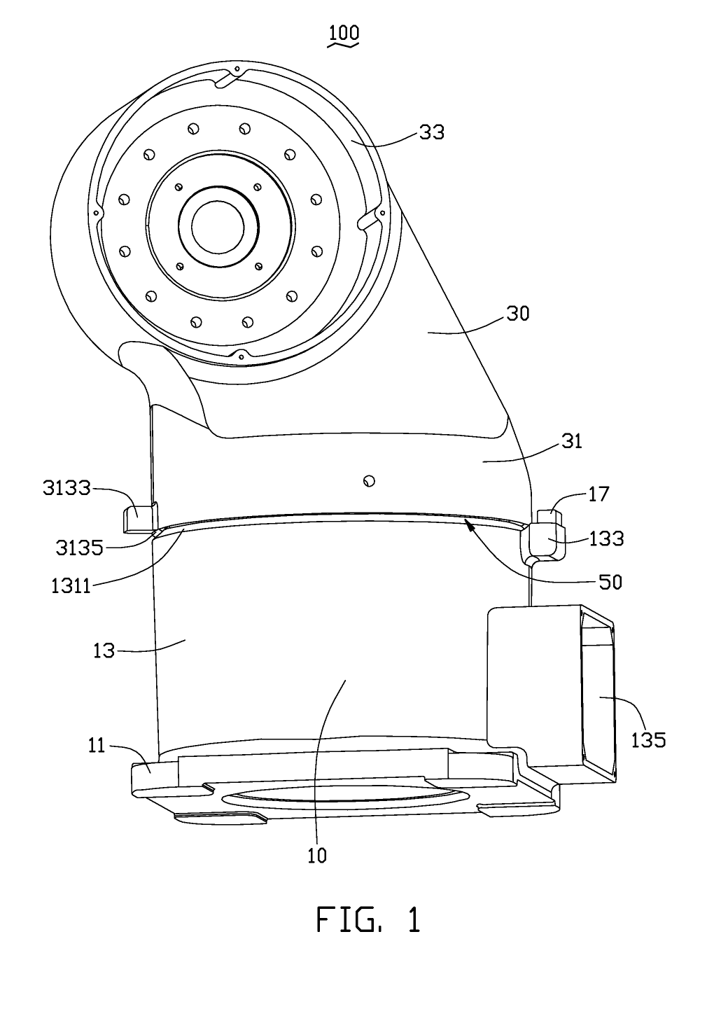

Referring to FIG. 1, an embodiment of a joint mechanism 100 includes first rotary unit 10 and a second rotary unit 30 rotatable relative to the first rotary unit 10.

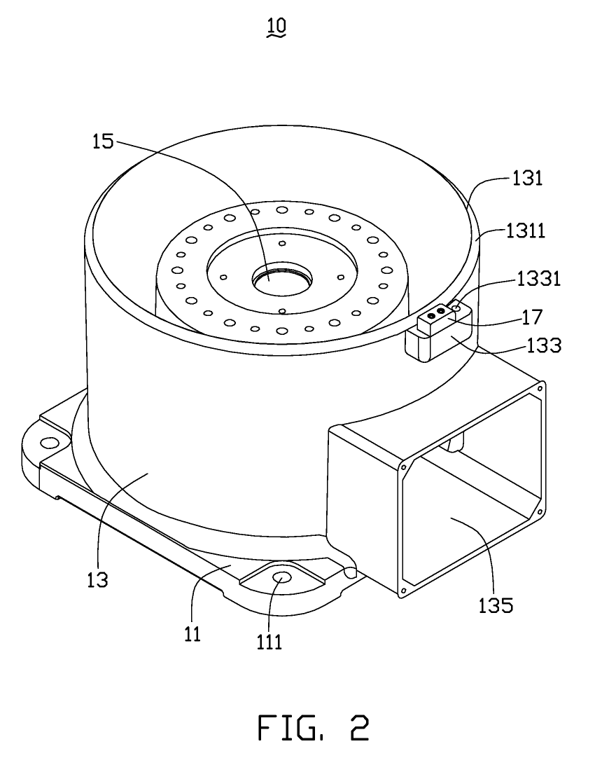

Referring to FIG. 2, the first rotary unit 10 includes a base 11, a housing 13 extending from the base 11, a first mounting portion 15 extending from the base 11, and a limiting portion 17.

The base 11 defines at least one mounting hole 111.

The housing 13 may be a cylinder extending from a surface of the base 11. The housing 13 includes a first joining end 131 defining an opening (not labeled), a first positioning portion 133, and a wire receptacle 135. The first joining end 131 is at an end of the housing 13 opposite to the base 11. The first joining end 131 is circular in shape so as to rotatably connect to the second rotary unit 30. The first joining end 131 defines a first chamfered rim 1311. A chamfered angle of the first chamfered rim 1311 may be in a range of about 30˜60 degrees, and is 45 degrees in the illustrated exemplary embodiment. An inner surface of the first chamfered rim 1311 has a length larger than an outer surface of the first chamfered rim 1311. The first positioning portion 133 is formed on an outside surface of the housing 13 and adjacent to the first joining end 131. A top surface of the first positioning portion 133 is substantially level with a base of the first chamfered rim 1311. The first positioning portion 133 defines a first positioning hole 1331. The wire receptacle 135 is formed on the outside surface of the housing 13 and adjacent to the base 11. The wire receptacle 135 has a channel communicating with an interior of the housing 13. The wire receptacle 135 is to receive wires.

The first mounting portion 15 extends from a center of the base 11 and is inside the housing 13. The first mounting portion 15 is to mount components such as a motor or a gearbox. An annular space is defined between the housing 13 and the first mounting portion 15 to receive the wires. The limiting portion 17 is detachably fixed on the first positioning portion 133 of the housing 13. The limiting portion 17 acts as a bumper and may be made of rubber or plastic.

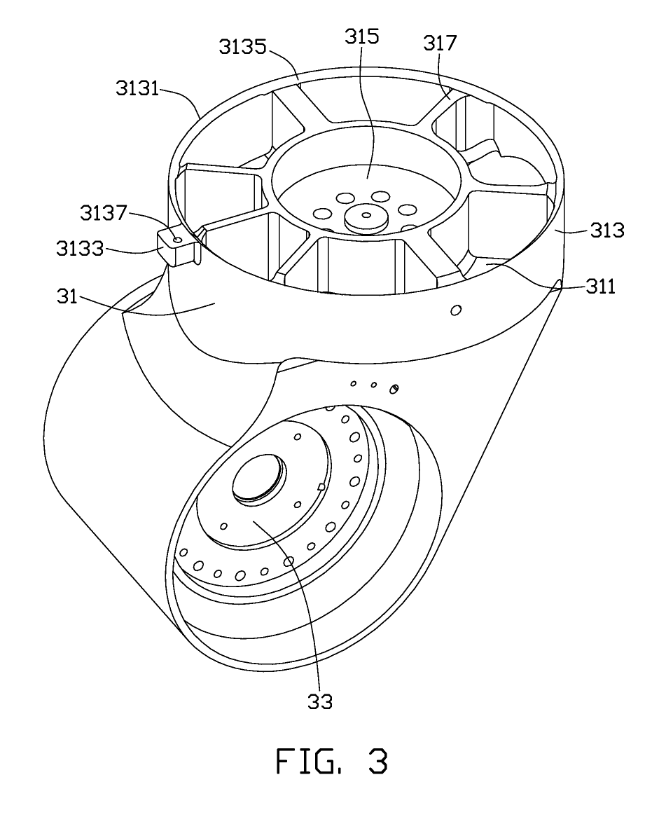

Referring to FIG. 3, the second rotary unit 30 includes a connecting seat 31 and a mounting seat 33.

The connecting seat 31 has a connecting surface 311, a sidewall 313 extending from an edge of the connecting surface 311, a second mounting portion 315 formed in a center of the connecting seat 31, and a plurality of strengthening ribs 317 formed between the sidewall 313 and the second mounting portion 315. The sidewall 313 has a second joining end 3131. The second joining end 3131 is at an end of the connecting seat 31 opposite to the mounting seat 33. The first joining end 3131 is circular in shape so as to rotatably connect to the first rotary unit 10. The second joining end 3131 defines a second chamfered rim 3135. A chamfered angle of the second chamfered rim 3135 may be in a range of about 30˜60 degrees, and is 45 degrees in the illustrated exemplary embodiment. An inner surface of the second chamfered rim 3135 has a length smaller than an outer surface of the second chamfered rim 3135. A second positioning portion 3133 is formed on an outside surface of the sidewall 313 and adjacent to the second joining end 3131. The second positioning portion 3133 defines a second positioning hole 3137. The gearbox received in the first mounting portion 15 is partially received in the second mounting portion 315. The strengthening ribs 317 are configured for strengthening the second rotary unit 30.

The mounting seat 33 is obliquely formed from the connecting seat 31. The mounting seat 33 is for mounting components such as a motor or a gearbox.

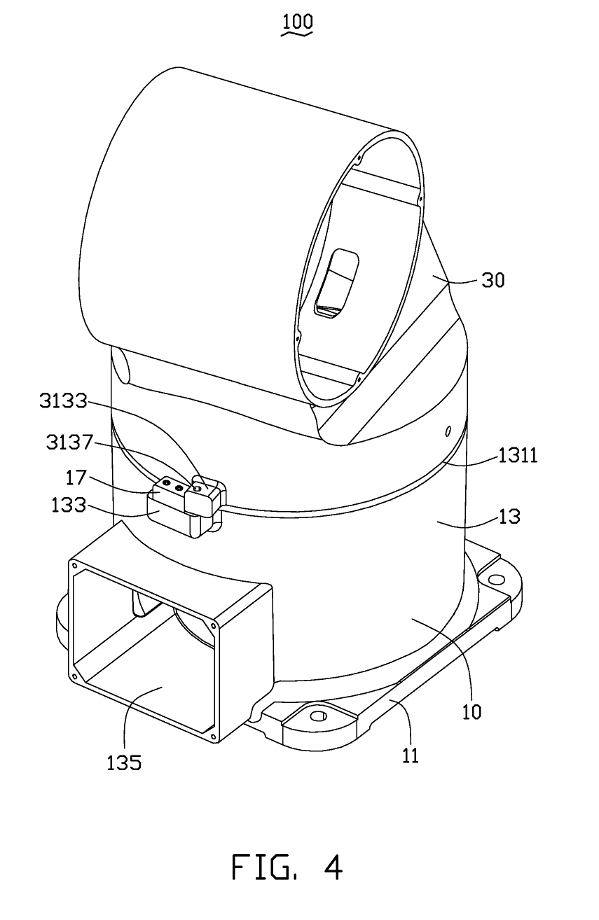

Referring to FIG. 4, the first and second joining ends 131, 3131 are adjoined to each other, thus connecting the first and second rotary units 10, 30. In a first state, the second positioning hole 3137 of the second rotary unit 30 is coaxial with the first positioning hole 1331 of the first rotary unit 10. To make sure the joint mechanism 100 be in the first state, a photosensitive sensor (not shown) is provided to sense whether there is light passing through the first positioning hole 1331 and second positioning hole 3137 or a pole (not shown) is provided to extend through the first positioning hole 1331 and second positioning hole 3137. The limiting portion 17 is to restrict/limit movement of the second positioning portion 3133, thus determining a rotatable range between the first rotary unit 10 and the second rotary unit 30. In the illustrated exemplary embodiment, the rotation angle is about 360 degrees. Therefore, wires received inside the first rotary unit 10 and the second rotary unit 30 are protected from over stretching due to over rotation between the first rotary unit 10 and the second rotary unit 30. In other embodiments, the first rotary unit 10 and the second rotary unit 30 can be connected to other rotary units. When the second positioning portion 3133 moves close to the limiting portion 17, the second positioning portion 3133 and the limiting portion 17 will not be damaged, due the limiting portion 17 being elastic and capable of reducing collision.

After the first rotary unit 10 and the second rotary unit 30 are connected together, the first and second joining ends 131, 3131 are adjoined to each other and the first and second chamfered rims 1311, 3135 cooperatively form a slanted groove 50 (FIG. 1). The groove 50 has an opening facing the first rotary unit 10 with the base 11. The first rotary unit 10 with the base 11 is positioned below the second rotary unit 30. Therefore, the groove 50 prevents oil or liquid from flowing into the robot via the joining portion of the first and second joining ends 131, 3131. In addition, oil or liquid cannot deposit at the jointing portion. Therefore, oil or liquid are guided away from entering into the interior of the robotic machine via the groove 50 while the first and second rotary units 10, 30 rotate relative to each other.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A joint mechanism, comprising:
a first rotary unit comprising a base and a first joining end, the first joining end defining a first chamfered rim; and
a second rotary unit comprising a second joining end to join to the first joining end, the second joining end defining a second chamfered rim, wherein the first chamfered rim and the second chamfered rim cooperatively form a slanted groove, and the groove communicates with an outside of the first and second rotary units and has an opening facing the base.

2. The joint mechanism of claim 1, wherein the first rotary unit further comprises a housing extending from the base, the first joining end is at an end of the housing opposite to the base; the second rotary unit comprises a connecting seat and a mounting seat, the second joining end is at an end of the connecting seat opposite to the mounting seat.

3. The joint mechanism of claim 2, wherein the housing of the first rotary unit further comprises a first positioning portion; the connecting seat of the second rotary unit forms a second positioning portion to engage with the first positioning portion.

4. The joint mechanism of claim 3, wherein the first positioning portion defines a first positioning hole, and the second positioning portion defines a second positioning hole; when the first positioning hole and the second positioning hole are positioned axially to each other, a first state of the first rotary unit and the second rotary unit is defined.

5. The joint mechanism of claim 4, wherein the first rotary unit further comprises a limiting portion detachably fixed on the first positioning portion of the housing.

6. The joint mechanism of claim 5, wherein the limiting portion is made of rubber.

7. The joint mechanism of claim 1, wherein the housing further comprises a wire receptacle for receiving wires.

8. The joint mechanism of claim 2, wherein the first rotary unit further comprises a first mounting portion extending from the base and inside the housing; the connecting seat of the second rotary unit further comprises a second mounting portion formed in the connecting seat and corresponding to the first mounting portion.

9. The joint mechanism of claim 8, wherein the connecting seat of the second rotary unit further comprises a plurality of strengthening ribs.

10. A joint mechanism comprising:
a first rotary unit comprising a first joining end, the first joining end defining a first chamfered rim, and an inner side of the first chamfered rim having a height larger than an outer side of the first chamfered rim; and
a second rotary unit comprising a second joining end to join to the first joining end, the second joining end defining a second chamfered rim, and an inner surface of the second chamfered rim having a length smaller than an outer surface of the second chamfered rim;
wherein the first rotary unit is positioned below the second rotary unit.

11. The joint mechanism of claim 10, wherein the first rotary unit further comprises a base and a housing extending from the base, the first joining end is at an end of the housing opposite to the base; the second rotary unit comprises a connecting seat and a mounting seat, the second joining end is at an end of the connecting seat opposite to the mounting seat.

12. The joint mechanism of claim 11, wherein the housing of the first rotary unit further comprises a first positioning portion; the connecting seat of the second rotary unit forms a second positioning portion to engage with the first positioning portion.

13. The joint mechanism of claim 12, wherein the first positioning portion defines a first positioning hole, and the second positioning portion defines a second positioning hole; when the first positioning hole and the second positioning hole are positioned axially to each other, a first state of the first rotary unit and the second rotary unit is defined.

14. The joint mechanism of claim 13, wherein the first rotary unit further comprises a limiting portion detachably fixed on the first positioning portion of the housing.

15. A joint mechanism comprising:
a first rotary unit comprising a first joining end, the first joining end defining a first chamfered rim; and
a second rotary unit comprising a second joining end to join to the first joining end, the second joining end defining a second chamfered rim;
wherein the first and second chamfered rims are slanted, thus guiding contaminants away from a joining portion of the first joining end and the second joining end.
